(19) United States
(12) Patent Application Publication
(10) Pub. No.: US 2026/0203485 A1
(43) Pub. Date: Jul. 16, 2026

(54) METHOD FOR SOLVING MOTION RESPONSE OF MOORED AQUACULTURE CAGE UNDER IRREGULAR WAVE ACTION

(71) Applicant: South China University of Technology, Guangzhou (CN)

(72) Inventors: Bo HONG, Guangzhou (CN); Mingjun LI, Guangzhou (CN)

(73) Assignee: South China University of Technology, Guangzhou (CN)

(21) Appl. No.: 19/567,128

(22) Filed: Mar. 14, 2026

(30) Foreign Application Priority Data
Aug. 19, 2025 (CN) 202511157706.3

(51) Int. Cl. G06F 30/28; A01K 61/65; G06F 111/10

(52) U.S. Cl. CPC G06F 30/28; A01K 61/65; G06F 2111/10

(57) ABSTRACT

A method for managing motion responses of a moored aquaculture cage under irregular wave action is disclosed, which pertains to the field of motion attitude calculation technology for marine engineering structures. The method comprises: according to given parameters of a JONSWAP spectrum, obtaining an irregular wave height time series and deriving the wavelets via FFT; simulating a reproducible irregular wave load by wavelet superposition within a numerical wave tank; and, based on the VOF model and overlapping grids, utilizing locally refined grids in critical regions of the flow field and applying a fluid-structure interaction method to simulate the attitude response of the floating aquaculture cage structure within a catenary mooring system under irregular wave loading in the numerical wave tank. The method eliminates the need for prolonged computation, and allows the application of identical irregular wave loads to different targets.

### TECHNICAL FIELD

The present disclosure pertains to the field of motion attitude calculation technology for marine engineering structures, particularly to a method for solving a motion response of a moored aquaculture cage under an irregular wave action.

### BACKGROUND

Irregular waves represent a common wave form in the actual marine environment. They are formed by the random superposition of numerous simple harmonic waves with varying frequencies, wave heights, and periods, featuring significant non-reproducibility and unpredictability. The load from such irregular waves can induce significant changes in the motion attitude of moored floating aquaculture cage structures. Consequently, the study of irregular waves holds considerable importance for coastal engineering, energy development, and disaster prediction.

Given the aforementioned issues, domestic scholars have conducted extensive research. For the study of irregular waves, the methods of push plate wave making and numerical simulation are typically employed. Owing to the inherent randomness of irregular waves, numerical simulation software often utilizes a random phase method. However, the errors introduced by this method in controlled experiments require prolonged simulation times to mitigate, thereby greatly increasing computational costs. On this basis, the present disclosure provides a boundary wave-generation method designed to simulate the generation of reproducible irregular waves. This method provides a reference for controlled experiments aimed at evaluating the motion attitude of catenary moored aquaculture cages under irregular wave action.

### SUMMARY

An objective of the present disclosure is to provide a method for solving a motion response of a moored aquaculture cage under an irregular wave action, which addresses the issue of non-reproducibility inherent in random irregular waves generated by conventional methods, reduces errors in controlled tests, and enables stable generation of irregular wave numerical simulations with predefined wave height time series.

In order to achieve the above-mentioned objective, the present disclosure provides a motion response of a moored aquaculture cage under an irregular wave action, including:
step I, according to parameters of a Joint North Sea Wave Project (JONSWAP) spectrum corresponding to a sea state reached by a random irregular wave, obtaining a spectral density of an ocean wave spectrum of the irregular wave by using a JONSWAP spectrum formula;
solving a dispersion equation via a Newton iteration method, and obtaining a wavenumber of the irregular wave;
calculating a wave height of each component based on the spectral density of the ocean wave spectrum and wavenumber of the irregular wave, generating a random phase, and obtaining a wave height time series through iteration;
decomposing the wave height time series into wavelets based on the Fast Fourier Transform (FFT), and determining parameter information of wavelets;
step II, establishing a fluid domain geometric model of an area where a mooring structure is located as a background tank region; in the background tank region, according to a maximum wave height of the irregular wave, determining a grid region of a wave surface fluid domain, and subtracting a target mooring structure by a subtraction operation to generate an overlapping fluid domain; using an interface between the overlapping fluid domain and the background tank as an overlapping grid interface, and establishing a flow field information exchange between the two regions;
wherein the fluid domain geometry model defines a continuous shape and physical properties of a computational domain, a length direction is a propagation direction of the irregular wave, and a height direction is a water depth direction of the background tank;
step III, based on a Volume of Fluid (VOF) model, constructing a grid model of the background tank and a catenary mooring structure, and performing a local encryption processing on the grid region of the wave surface fluid domain in the background tank, and setting a slow grid volume growth rate;
defining an irregular wave inlet boundary, a wave absorption boundary, and a front and rear boundary of the tank, and a bottom boundary of the tank as a velocity inlet boundary condition; defining a top boundary of the tank as a pressure outlet boundary condition; defining a depth of the irregular wave numerical wave tank; and defining a seawater-air interface as a reference plane for the irregular wave generation;
step IV, constructing a local coordinate system of the background tank and a coordinate system of the catenary mooring structure;
defining a surface boundary of a target catenary mooring structure as a wall boundary condition;
defining a fluid-solid interaction module to simulate a dynamic and bidirectional interaction between fluid and solid targets; setting an inertia moment of a target catenary model with respect to the coordinate system of the catenary mooring structure, along with a mass of the target catenary mooring structure;
determining relative positions of two ends of the catenary according to the local coordinate system of the background tank and the coordinate system of the catenary mooring structure, and setting a relaxation length and a stiffness of the catenary;
step V, incorporating the wavelet parameters obtained from the decomposition in step I into the wavelet of a superimposed wave using a superimposed-wave boundary wave-generation method, so as to generate a reproducible irregular wave load; defining a length of a wave-absorbing damping wave to be twice a wavelength of the wavelet with the maximum wavelength; and setting velocities of the wave absorption boundary, and the front and rear boundary of the tank, and the bottom boundary of the tank to 0 m/s.
step VI, initializing the grid model, and taking initial states of sway, heave, and pitch motions of the target catenary mooring structure as a reference, performing a flow field calculation on the grid model of the target catenary mooring structure until reaching an end time t_{end} of the calculation, and terminating the calculation.

Further, the parameters of the JONSWAP spectrum include a significant wave height, a peak period, a peak enhancement factor and a mean wave period.

Further, the spectral density of the ocean wave spectrum is expressed as follows:

$$S ( f ) = β * {H}_{s}^{2} * {T}_{p}^{- 4} * {f}^{- 5} * exp ( - 1.25 * {( {T}_{P} * f )}^{- 4} ) * {γ}^{exp ( - ( {T}_{P} * {f}^{- 1} ) \hat{} 2 / ( 2 * {σ}^{2} ) )} ;$$

where S(f) is an energy density of the ocean wave spectrum, Hₛ is a significant wave height, T_{P} is a peak period, f is a frequency, γ is a peak enhancement factor, σ is a peak width parameter, and β is a scale parameter.

Further, the expression of the dispersion equation is:

$${ω}^{2} = g * k * tanh ( kh ) ;$$

where ω is a wave circular frequency, g is a gravity acceleration, k is a wavenumber, and h is a water depth.

Further, the fluid domain geometric model of the area where the mooring structure is located is set to a cuboid.

Further, in the local coordinate system of the background tank, an origin of the coordinate system is at an interface between air and seawater, an x₁ direction is a direction of wave surface transmission, a z₁ direction is a depth direction of the tank, and a y₁ direction is a width direction of the tank; in the coordinate system of the catenary mooring structure, an origin of the coordinate system is a centroid of the mooring structure, an x₂ direction is a length direction, a z₂ direction is a height direction, and a y₂ direction is a width direction.

Further, the step of initializing the grid model includes:
step 1, determining a wave surface position according to a position vector field function, taking an irregular wave theoretical model as a linear superimposed wave model, and according to the wavelet of the wavelet parameter information determined in step I, setting an initial time t=0 of a waveform equation, and previewing a waveform of the generated superimposed wave for waveform consistency with the wave height time series;
step 2, performing a grid model initialization on the grid model of the tank and the target catenary mooring structure based on a VOF method, activating an interface between the grid model of the background tank and the target catenary mooring structure, and then performing a data exchange by interpolation;
step 3, initializing the catenary to make the force thereof at t=0 to be 0; and
step 4, performing a hole-cutting on the fluid domain grid model based on an overlapping grid theory, identifying and removing invalid solid regions; and defining information interpolation between the grid model of the background tank and the target catenary mooring structure to be of a second-order accuracy.

Therefore, the present disclosure adopts the above-mentioned method for solving a motion response of a moored aquaculture cage under an irregular wave action, and has the following technical effects:

(1) In the present disclosure, the method employs local grid refinement and wavelet superposition to reconstruct the wave generation boundary, thereby producing irregular waves with a known wave height time series. It offers more accurate control over the generated wave surface compared to conventional wave-generation methods and is characterized by rapid and straightforward wave generation, ease of data acquisition, and a high success rate.

(2) In the present disclosure, the overlapping grid is adopted, which allows for a more accurate depiction of the details of the catenary moored aquaculture cage model, thereby reducing the risk of solution divergence inherent in conventional deforming grid methods and enabling the evaluation of the motion attitude of deep-sea structures under irregular wave action.

(3) In the present disclosure, the wavelets constituting the wave height time series are derived via the FFT of the wave height time series. This achieves stable and reliable generation within the numerical simulation for irregular waves with a known wave height time series, which effectively addresses the issue of non-reproducibility associated with randomly generated irregular waves from conventional methods and can reduce errors in controlled experiments.

Further detailed descriptions of the technical scheme of the present disclosure can be found in the accompanying drawings and embodiments.

### BRIEF DESCRIPTION OF THE DRAWINGS

FIG. 1 is a fluid domain geometric model in an embodiment of a method for solving a motion response of a moored aquaculture cage under an irregular wave action;

FIG. 2 is a schematic diagram showing a structure of an overlapping grid in an embodiment of a method for solving a motion response of a moored aquaculture cage under an irregular wave action;

FIG. 3 is a schematic diagram of an overlapping boundary grid divided based on the overlapping grid theory in an embodiment of a method for solving a motion response of a moored aquaculture cage under an irregular wave action;

FIG. 4 is a comparative result between a generated irregular wave and a known wave height time series in an embodiment of a method for solving a motion response of a moored aquaculture cage under an irregular wave action;

FIG. 5 is a velocity vector diagram of a flow field when a mooring structure is subjected to irregular wave load in an embodiment of a method for solving a motion response of a moored aquaculture cage under an irregular wave action;

FIG. 6 is a diagram showing a planar three-degree-of-freedom variation of a catenary mooring structure in an embodiment of a method for solving a motion response of a moored aquaculture cage under an irregular wave action, wherein (a) represents surge, (b) represents pitch, and (c) represents heave.

### DETAILED DESCRIPTION OF THE EMBODIMENTS

The following embodiments provide a more detailed explanation of the present disclosure. The objective of disclosing the present disclosure is to protect any variations and improvements within the scope of the present disclosure, and the present disclosure is not limited to the embodiments described below.

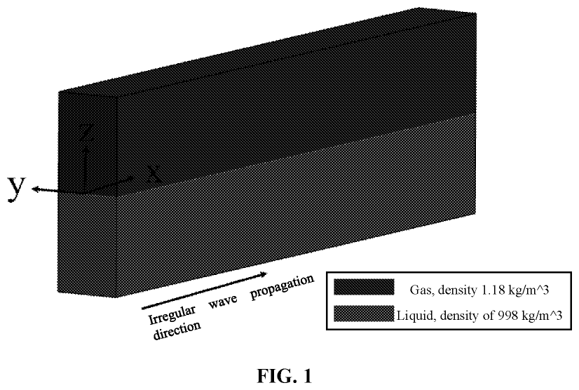

As shown in FIG. 1, the present disclosure provides a method for solving a motion response of a moored aquaculture cage under an irregular wave action. The method includes: based on the VOF model and the overlapping grid method, the required wave height time series is generated through the known parameters of the JONSWAP spectrum and the FFT is performed to obtain the wavelets; and the reproducible irregular wave load is simulated via wavelet superposition in the numerical wave tank. Specifically, the k−ε turbulence model is employed to generate the same irregular wave as the obtained wave height time series in the tank containing gas and liquid, and to detect the influence of these generated irregular waves on the motion attitude of the catenary mooring structure. Concurrently, by utilizing locally refined grids in key flow field regions, the fluid-structure interaction method is applied to simulate the attitude response of the floating aquaculture cage structure within the catenary mooring system under irregular wave loading in the numerical wave tank. Compared to conventional methods of push plate wave making and plate-retraction wave making, this method improves the accuracy of the generated wave surface, enables stable reproduction of irregular waves, eliminates the need for prolonged computation to mitigate uncertainties inherent in random wave generation, reduces calculation time, and allows the application of identical irregular wave loads to different targets, which provides a reference for attitude control of floating aquaculture cage structures with catenary mooring systems.

In this embodiment, the adopted parameters of the JONSWAP spectrum are as follows: significant wave height Hₛ=3.5 m, peak period T_{P}=10.5 s, peak enhancement factor γ=2.2, and average wave period Tₘ=8.7 s. The employed catenary mooring structure is a cuboid, with a weight of 2050 kg, a length of 2 m, a width of 1 m, and a height of 2 m. Its center of gravity is initialized at the water surface height. The diagonal components of the inertia moment tensor are [854.17, 1366.67, 854.17] kg-m². The catenary is defined in a preloaded state, with a preload of 100 N, a stiffness of 5000.0 N/m, and a mass per unit length of 0.005 kg/m.

Based on the above parameters, a method for solving a motion response of a moored aquaculture cage under an irregular wave action is provided. The specific process includes:
step I, firstly, according to parameters of the JONSWAP spectrum corresponding to the sea state reached by the random irregular wave, the spectral density of the ocean wave spectrum of the irregular wave is obtained by the JONSWAP spectrum formula.

Wherein the spectral density of the ocean wave spectrum is expressed as follows:

$$S ( f ) = β * {H}_{s}^{2} * {T}_{p}^{- 4} * {f}^{- 5} * exp ( - 1.25 * {( {T}_{P} * f )}^{- 4} ) * {γ}^{exp ( - ( {T}_{P} * {f}^{- 1} ) \hat{} 2 / ( 2 * {σ}^{2} ) )} ;$$

where S(f) is the energy density of the ocean wave spectrum, Hₛ is the significant wave height, T_{P} is the peak period, f is the frequency, γ is the peak enhancement factor, σ is the peak width parameter, and β is the scale parameter. When f≤1/T_{P}, σ=0.07; and when f>1/T_{P}, σ=0.09. β=0.0624*(1.094−0.01915*ln(γ))/(0.23+0.0336*γ−0.185*(1.9+γ)⁻¹), and here β=0.27.

Secondly, the dispersion equation ω²=g*k*tan h(kh) is solved via the Newton iteration method, and the wavenumber k of the irregular wave is obtained. where ω is the wave circular frequency, g is the gravity acceleration, with a value of 9.81 m/s²; and h is the water depth, with a value of 30 m.

Thirdly, based on the spectral density of the ocean wave spectrum S(f) and wavenumber k of the irregular wave, the random phase θ is generated, and the wave height of each component is calculated by h=\sqrt{2S(f)*Δf}, where Δf denotes the frequency interval and is set to 0.0011. The wave height time series η=η+h(i)*cos(2π*f(i)*t−k(i)*x+θ(i) is obtained by iteration. Here, x is the initial spatial position of wave generation, typically x=0; i=1, 2, . . . , N, N is the number of frequency components, in this embodiment, N=450; the time series is t=0:1/fₛ:60, fₛ is the sampling frequency, fₛ=200 Hz in this embodiment.

Fourthly, the wave height time series is decomposed into wavelets based on the FFT.

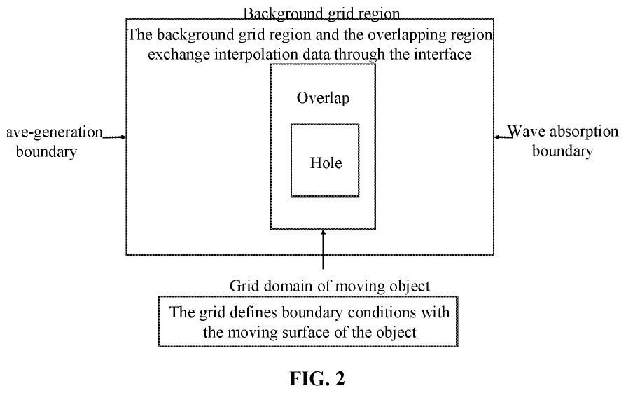

Step II: the geometric model of the fluid domain in the area where the anchor structure is located is established, and the continuous shape and physical properties of the computational domain are defined. The geometric model of the fluid domain is configured as a cuboid. The length, width, and depth of the geometric model of the fluid domain are set to 200 m, 2 m, and 60 m, respectively. The length direction is the propagation direction of the irregular wave. The height direction corresponds to the water depth direction of the test tank, with a water depth of 30 m. The gas-liquid interface up and down within 5 m of the mean water level is designated as the wave surface fluid domain grid region, which is determined based on the maximum wave height of the irregular wave. For the subsequent generation of the grid model, grid refinement is performed in this region to reduce the risk of calculation divergence and errors and to increase the accuracy of irregular wave generation. Based on the irregular wave and the mooring structure, the overlapping grid boundary is divided, and the overlapping fluid domain is generated via a subtraction operation, i.e., the moving fluid domain surrounding the target structure, which can move after being affected by the irregular wave load, as shown in FIG. 2.

The geometric model of the fluid domain is assigned to the background tank to serve as the static wave-generation region; the overlapping fluid domain is assigned to the mooring structure region. Subsequently, the overlapping grid interface between the mooring structure region and the background tank is generated, whereby flow field information exchange between the two regions is established.

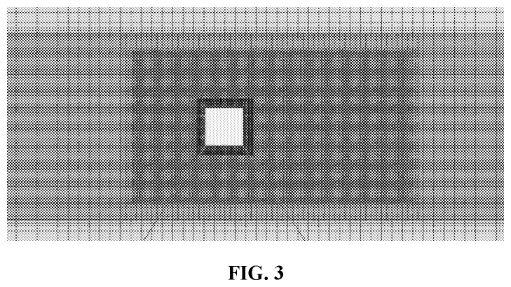

Step III: the grid model of the background tank and the moving fluid domain surrounding the target structure (i.e., the overlapping fluid domain) are generated. The interface between the overlapping fluid domain and the background tank region is defined as the overlapping grid boundary condition. Subsequently, local grid refinement processing is performed on the grid region of the wave surface fluid domain, and the slow grid volume growth rate is set, as shown in FIG. 3.

The irregular wave inlet boundary, the wave absorption boundary, the front and rear boundary of the tank, and the bottom boundary of the tank are defined as the velocity inlet boundary condition; the top boundary of the tank is defined as the pressure outlet boundary condition. Compared with the conventional boundary condition setting method for numerical wave tank, the method enables the complete elimination of boundary reflection effects and significantly simplifies the control logic of the wave field.

The depth of the irregular wave numerical wave tank is defined; and the seawater-air interface is defined as a reference plane for the irregular wave generation. Specifically, based on the VOF model, the Eulerian multiphase liquid (water) is added with its density defined as 997.561 kg/m³, and the Eulerian multiphase gas (air) is added with its density defined as 1.18415 kg/m³. An internal solitary wave numerical wave tank is then defined. The positions of the liquid and gas are set along the tank's depth direction, and the interface between the liquid and gas is defined as the reference plane for irregular wave generation.

Step IV, the local coordinate system of the background tank and the coordinate system of the catenary mooring structure are constructed. In the local coordinate system of the background tank, the origin of the coordinate system is at the interface between air and seawater, and the embodiment is set at the midpoint of the interface between liquid and gas at the wave-generation boundary. The x₁ direction is the direction of wave surface transmission, the z₁ direction is the depth direction of the tank, and the y₁ direction is the width direction of the tank. In the coordinate system of the catenary mooring structure, the origin of the coordinate system is the centroid of the mooring structure, the x₂ direction is the length direction, the z₂ direction is the height direction, and the y₂ direction is the width direction.

The surface boundary of the catenary mooring structure is defined as the wall boundary condition; and the surface controls are defined to prevent the generation of a prismatic layer grid at the interface between the overlapping fluid domain and the background tank, thereby ensuring that the prismatic layer grid is attached exclusively to the surface of the submerged buoy.

The fluid-solid interaction module is defined to simulate the dynamic and bidirectional interaction between fluid and solid targets. The diagonal component of the inertia moment of the target catenary model with respect to the coordinate system of the catenary mooring structure is set to be [854.17,1366.67,854.17] kg·m², and the mass of the target catenary model is set to be 2050 kg.

The relative positions of two ends of the catenary are determined according to the local coordinate system of the background tank and the coordinate system of the catenary mooring structure. The catenary is set as the preloaded state, with the preload of 100 N, the stiffness of 5000.0 N/m, and the mass per unit length of 0.005 kg/m.

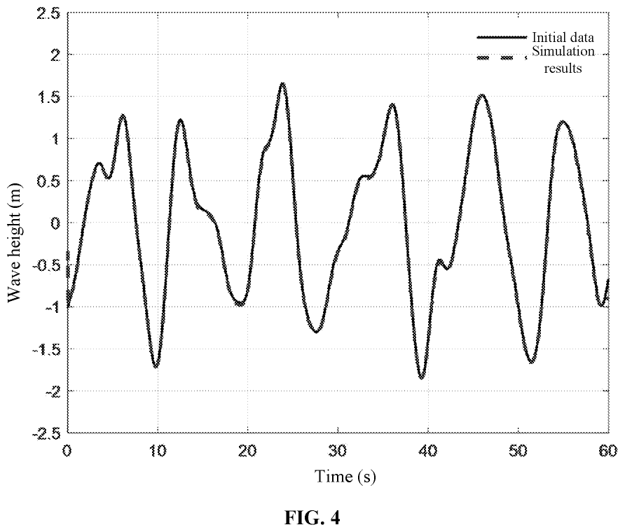

Step V, the wavelet parameters obtained from the decomposition in step I are incorporated into the wavelet of the superimposed wave using the superimposed-wave boundary wave-generation method, so as to generate the reproducible irregular wave load. Specifically, step I is decomposed to obtain the parameters of the first fifty wavelets with the maximum amplitude, including phase, amplitude and period, which are added to the wavelet of the superimposed wave one by one, as shown in FIG. 4.

Damping wave is activated at the wave absorption boundary to eliminate non-physical reflections of irregular waves at the boundary of the numerical wave tank, thus ensuring the accuracy of the results. The length of the wave-absorbing damping wave is twice the wavelength of the wavelet with the maximum wavelength, which is 121 m, and the velocities of the wave absorption boundary, the front and rear boundary of the tank, and the bottom boundary of the tank are set to 0 m/s.

Step VI, firstly, the grid model is initialized as follows:

(1) The liquid region range is established according to the position vector field function to determine the sea surface position (i.e., the wave surface position). A linear superimposed wave model is employed as the irregular wave theoretical model. The generation of irregular wave waveforms is previewed using the superimposed-wave boundary wave-generation method, thus ensuring that the recorded wave height series is consistent with the wave height time series obtained in step I. This prevents the occurrence of waveform inconsistencies after computation commences and avoids a waste of computational resources. During this process, the initial time of the waveform equation is set to t=0, the waveform of the irregular wave propagates forward over time, and the wave height series is recorded by a wave height meter.

(2) The initialization is performed on the grid model of the background tank and the target catenary mooring structure based on the VOF method, so that the interface between the grid model of the background tank and the target catenary mooring structure is activated to achieve data exchange.

(3) The catenary is initialized to make the force thereof at t=0 to be 0.

(4) The hole-cutting is performed on the fluid domain grid model based on the overlapping grid theory, and the invalid solid regions are identified and removed. This ensures that the solver performs calculations only within the fluid region, eliminating redundant computations in invalid regions and reducing the computational load. And the information interpolation between the grid model of the background tank and the target catenary mooring structure is defined to be of the second-order accuracy. This setting enhances data transfer accuracy and reduces numerical dissipation and dispersion errors.

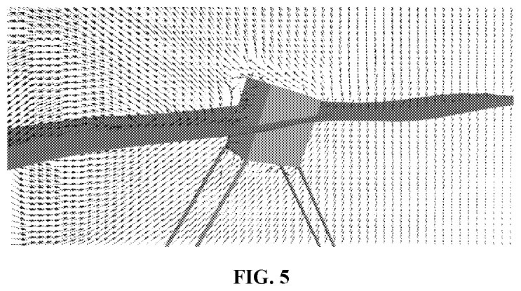

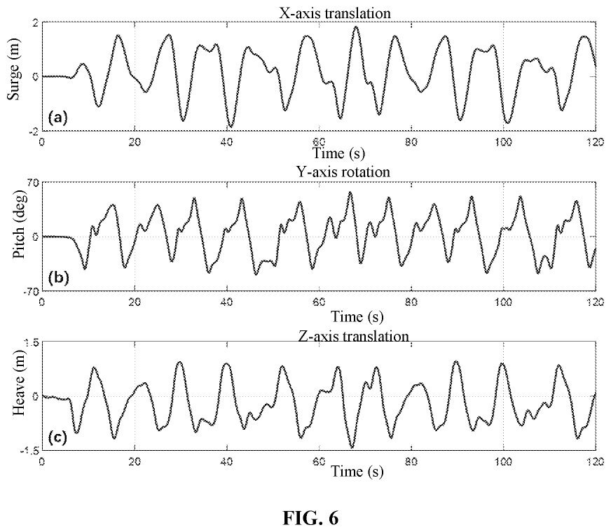

Secondly, the initial states of sway, heave, and pitch motions of the target catenary mooring structure are taken as a reference, the reports, monitors, and plots of its x-direction displacement, z-direction displacement, and y-axis rotation over time are generated. The calculation time step is specified as 0.025 s. The flow field calculation is performed on the grid model of the target catenary mooring structure until reaching the end time t_{end} of the calculation, at which point the calculation is terminated. Subsequently, the velocity vector variation diagram of the flow field throughout the entire simulation, as well as the simulation results depicting the planar three-degree-of-freedom motion of the target structure under the generated irregular wave action, are obtained, as shown in FIGS. 5-6.

Therefore, the present disclosure employs the aforementioned method for solving a motion response of a moored aquaculture cage under an irregular wave action. This enables the stable reproduction of irregular waves with a known wave height time series, improves the accuracy and controllability of irregular wave generation, and realizes the numerical simulation of the effects induced by marine irregular wave loads on moored aquaculture cage structures.

Finally, it should be noted that the above embodiments are merely used for describing the technical solutions of the present disclosure, rather than limiting the same. Although the present disclosure has been described in detail with reference to the preferred examples, those of ordinary skill in the art should understand that the technical solutions of the present disclosure may still be modified or equivalently replaced. However, these modifications or substitutions should not make the modified technical solutions deviate from the spirit and scope of the technical solutions of the present disclosure.

What is claimed is:

1. A method for solving a motion response of a moored aquaculture cage under an irregular wave action, comprising:
step I, according to parameters of a JONSWAP spectrum corresponding to a sea state reached by a random irregular wave, obtaining a spectral density of an ocean wave spectrum of the irregular wave using a JONSWAP spectrum formula;
solving a dispersion equation via a Newton iteration method, and obtaining a wavenumber of the irregular wave;
calculating a wave height of each component based on the spectral density of the ocean wave spectrum and wavenumber of the irregular wave, generating a random phase, and obtaining a wave height time series through iteration; and
decomposing the wave height time series into wavelets based on FFT, and determining parameter information of the wavelets;
step II, establishing a fluid domain geometric model of an area where a mooring structure is located as a background tank region; in the background tank region, according to a maximum wave height of the irregular wave, determining a grid region of a wave surface fluid domain, and subtracting a target mooring structure by a subtraction operation to generate an overlapping fluid domain; establishing an interface between the overlapping fluid domain and the background tank as an overlapping grid interface, and establishing a flow field information exchange between the two regions;
wherein the fluid domain geometry model defines a continuous shape and physical properties of a computational domain, a length direction is a propagation direction of the irregular wave, and a height direction is a water depth direction of the background tank;
step III, based on a VOF model, constructing a grid model of the background tank and a catenary mooring structure, and performing a local encryption processing on the grid region of the wave surface fluid domain in the background tank, and setting a slow grid volume growth rate; and
defining an irregular wave inlet boundary, a wave absorption boundary, and a front and rear boundary of the tank, defining a bottom boundary of the tank as a velocity inlet boundary condition, defining a top boundary of the tank as a pressure outlet boundary condition; defining a depth of an irregular wave numerical wave tank; and defining a seawater-air interface as a reference plane for an irregular wave generation;
step IV, constructing a local coordinate system of the background tank and a coordinate system of the catenary mooring structure;
defining a surface boundary of a target catenary mooring structure as a wall boundary condition;
defining a fluid-solid interaction module to simulate a dynamic and bidirectional interaction between fluid and solid targets; setting an inertia moment of a target catenary model with respect to the coordinate system of the catenary mooring structure, along with a mass of the target catenary mooring structure; and
determining relative positions of two ends of the catenary according to the local coordinate system of the background tank and the coordinate system of the catenary mooring structure, and setting a relaxation length and a stiffness of the catenary;
step V, incorporating the wavelet parameters obtained from the decomposition in step I into the wavelet of a superimposed wave using a superimposed-wave boundary wave-generation method, so as to generate a reproducible irregular wave load, and defining a length of a wave-absorbing damping wave to be twice a wavelength of the wavelet with the maximum wavelength; and setting velocities of the wave absorption boundary, and the front and rear boundary of the tank, and the bottom boundary of the tank to 0 m/s; and
step VI, initializing the grid model, and taking initial states of sway, heave, and pitch motions of the target catenary mooring structure as a reference, performing a flow field calculation on the grid model of the target catenary mooring structure until reaching an end time t_{end} of the calculation, and terminating the calculation.

2. The method for solving a motion response of a moored aquaculture cage under an irregular wave action according to claim 1, wherein the parameters of the JONSWAP spectrum comprise a significant wave height, a peak period, a peak enhancement factor and a mean wave period.

3. The method for solving a motion response of a moored aquaculture cage under an irregular wave action according to claim 1, wherein the spectral density of the ocean wave spectrum is expressed as follows:
$$S ( f ) = β * {H}_{s}^{2} * {T}_{p}^{- 4} * {f}^{- 5} * exp ( - 1.25 * {( {T}_{P} * f )}^{- 4} ) * {γ}^{exp ( - ( {T}_{P} * {f}^{- 1} ) \hat{} 2 / ( 2 * {σ}^{2} ) )} ;$$
where S(f) is an energy density of the ocean wave spectrum, Hₛ is a significant wave height, T_{P} is a peak period, f is a frequency, γ is a peak enhancement factor, σ is a peak width parameter, and β is a scale parameter.

4. The method for solving a motion response of a moored aquaculture cage under an irregular wave action according to claim 1, wherein the expression of the dispersion equation is:
$${ω}^{2} = g * k * tanh ( kh ) ;$$
where ω is a wave circular frequency, g is a gravity acceleration, k is a wavenumber, and h is a water depth.

5. The method for solving a motion response of a moored aquaculture cage under an irregular wave action according to claim 1, wherein the fluid domain geometric model of the area where the mooring structure is located is set to a cuboid.

6. The method for solving a motion response of a moored aquaculture cage under an irregular wave action according to claim 1, wherein in the local coordinate system of the background tank, an origin of the coordinate system is at an interface between air and seawater, an x₁ direction is a direction of wave surface transmission, a z₁ direction is a depth direction of the tank, and a y₁ direction is a width direction of the tank; and in the coordinate system of the catenary mooring structure, an origin of the coordinate system is a centroid of the mooring structure, an x₂ direction is a length direction, a z₂ direction is a height direction, and a y₂ direction is a width direction.

7. The method for solving a motion response of a moored aquaculture cage under an irregular wave action according to claim 1, wherein the step of initializing the grid model comprises:
step 1, determining a wave surface position according to a position vector field function, taking an irregular wave theoretical model as a linear superimposed wave model, and according to the wavelet of the wavelet parameter information determined in step I, setting an initial time t=0 of a waveform equation, and previewing a waveform of the generated superimposed wave for waveform consistency with the wave height time series;
step 2, performing a grid model initialization on the grid model of the tank and the target catenary mooring structure based on a VOF method, activating an interface between the grid model of the background tank and the target catenary mooring structure, and then performing a data exchange by interpolation;
step 3, initializing the catenary to make force thereof at t=0 to be 0; and
step 4, performing a hole-cutting on the fluid domain grid model based on an overlapping grid theory, identifying and removing invalid solid regions; and defining information interpolation between the grid model of the background tank and the target catenary mooring structure to be of a second-order accuracy.
